(19) United States
(12) Patent Application Publication
(10) Pub. No.: US 2025/0105247 A1
(43) Pub. Date: Mar. 27, 2025

(54) MANUFACTURING METHOD OF LITHIUM BATTERY NEGATIVE ELECTRODE

(71) Applicant: NAN YA PLASTICS CORPORATION, Taipei City (TW)

(72) Inventors: Te-Chao Liao, Taipei City (TW); Wei-Sheng Cheng, Taipei City (TW); Yu-Chi Hsieh, Taipei City (TW)

(73) Assignee: NAN YA PLASTICS CORPORATION, Taipei City (TW)

(21) Appl. No.: 18/498,071

(22) Filed: Oct. 31, 2023

(30) Foreign Application Priority Data
Sep. 23, 2023 (TW) 112136450

(51) Int. Cl. H01M 4/04; H01M 4/02; H01M 4/36; H01M 4/38; H01M 4/62

(52) U.S. Cl. CPC H01M 4/0452; H01M 4/0402; H01M 4/366; H01M 4/382; H01M 4/622; H01M 2004/027

(57) ABSTRACT

A manufacturing method of a lithium battery negative electrode at least includes the following steps. An electroplating equipment is provided, wherein the electroplating equipment has a drying chamber, and the drying chamber includes an electroplating tank, an electroplating wheel set, and a film sticking wheel set. A copper foil is disposed in the drying chamber. The electroplating wheel set transports the copper foil to form a lithium metal layer on the copper foil, and the copper foil and the lithium metal layer form a copper-lithium composite metal layer. The film sticking wheel set transports the copper-lithium composite metal layer and attaches a protective film to the copper-lithium composite metal layer.

### CROSS-REFERENCE TO RELATED APPLICATION

This application claims the priority benefit of Taiwan application serial no. 112136450, filed on Sep. 23, 2023. The entirety of the above-mentioned patent application is hereby incorporated by reference herein and made a part of this specification.

### BACKGROUND OF THE INVENTION

### Field of the Invention

The invention relates to a manufacturing method of a lithium battery negative electrode.

### Description of Related Art

Lithium metal is the key material for negative electrode of lithium batteries. However, due to the high activity thereof, lithium metal readily reacts with water, oxygen, etc., and is oxidized and loses the activity thereof. This affects the performance of the lithium batteries. Therefore, how to improve the negative electrode of lithium batteries is actually a key factor in the future development of lithium batteries.

### SUMMARY OF THE INVENTION

The invention provides a manufacturing method of a lithium battery negative electrode. A composite negative electrode structure produced by the method may effectively improve the performance of a lithium battery and facilitate mass production.

A manufacturing method of a lithium battery negative electrode of the invention at least includes the following steps. An electroplating equipment is provided, wherein the electroplating equipment has a drying chamber, and the drying chamber includes an electroplating tank, an electroplating wheel set, and a film sticking wheel set. A copper foil is disposed in the drying chamber. The electroplating wheel set transports the copper foil to form a lithium metal layer on the copper foil, and the copper foil and the lithium metal layer form a copper-lithium composite metal layer. The film sticking wheel set transports the copper-lithium composite metal layer and attaches a protective film to the copper-lithium composite metal layer.

In an embodiment of the invention, the electroplating tank includes a first electrode, and the electroplating wheel set includes a first guide wheel and a second guide wheel disposed in the electroplating tank and a first conductive wheel and a second conductive wheel disposed outside the electroplating tank. The first guide wheel and the second guide wheel are configured so that the copper foil in the electroplating tank is parallel to the first electrode. The first conductive wheel and the second conductive wheel are used as second electrodes.

In an embodiment of the invention, the drying chamber further includes a copper foil supply device and a protective film supply device, the copper foil supply device is connected to the electroplating wheel set, and the protective film supply device is connected to the film sticking wheel set.

In an embodiment of the invention, a material of the protective film includes a polyimide film, a polyester film, or a water and gas barrier film.

In an embodiment of the invention, the drying chamber further includes a drying device, and the drying device is configured to remove an organic solvent on the copper-lithium composite metal layer.

In an embodiment of the invention, the drying device includes an air knife, a roller, an infrared heater, or a combination thereof.

In an embodiment of the invention, an environment of the drying chamber is formed by an inert gas.

In an embodiment of the invention, the protective film at least completely covers a surface of the lithium metal layer.

In an embodiment of the invention, the protective film is directly in contact with the lithium metal layer and the copper foil.

In an embodiment of the invention, an electroplating solution in the electroplating tank includes a lithium salt and an organic solvent, and the lithium salt includes lithium hexafluorophosphate, lithium hexafluoroborate, lithium bis(trifluoromethylsulfonate)amide, or a combination thereof, and the organic solvent includes ethylene carbonate, propylene carbonate, dimethyl carbonate, glycol dimethyl ether, dimethyl ether, or a combination thereof.

Based on the above, the lithium battery negative electrode of the invention is manufactured in the drying chamber, and via the electroplating wheel set in the drying room, lithium metal may be continuously deposited on the copper foil in the electroplating tank to form the copper-lithium composite metal layer. And via the film sticking wheel set in the drying chamber, the protective film may be continuously attached to the copper-lithium composite metal layer pulled out from the electroplating tank. In this way, the low-reactivity copper foil and protective film may effectively reduce the probability of lithium metal being oxidized, so the composite negative electrode structure produced thereby may effectively improve the performance of lithium batteries and facilitate mass production.

In order to make the aforementioned features and advantages of the disclosure more comprehensible, embodiments accompanied with figures are described in detail below.

### BRIEF DESCRIPTION OF THE DRAWINGS

FIG. 1 is a flowchart of a manufacturing method of a lithium battery negative electrode of an embodiment of the invention.

FIG. 2 is a schematic diagram of an electroplating equipment of an embodiment of the invention.

FIG. 3 is a schematic cross-sectional diagram of a lithium battery negative electrode of an embodiment of the invention.

FIG. 4 is a schematic cross-sectional diagram of a lithium battery negative electrode of another embodiment of the invention.

### DESCRIPTION OF THE EMBODIMENTS

In the following detailed description, for purposes of illustration and not limitation, exemplary embodiments disclosing specific details are set forth in order to provide a thorough understanding of the various principles of the invention. It will be apparent, however, to one of ordinary skill in the art, having the benefit of this disclosure, that the invention may be practiced in other embodiments that depart from the specific details disclosed herein. Moreover, descriptions of well-known devices, methods, materials, and other specific details may be omitted so as not to obscure the description of the various principles of the invention.

Herein, a range indicated by “one value to another value” is a general representation which avoids enumerating all values in the range in the specification. Therefore, the recitation of a specific numerical range covers any number within this numerical range and any smaller numerical range bounded by any number within that numerical range as if such any number and such smaller numerical ranges were expressly written in the specification.

Unless otherwise stated, the term “between” used in this specification to define numerical ranges is intended to cover ranges equal to and between the stated endpoints.

For example, if the size range is between a first value and a second value, it means that the size range may cover the first value, the second value, and any value between the first value and the second value.

In this specification, non-limiting terms (such as: may, can, for example, or other similar terms) refer to an optional or selective implementation, inclusion, addition, or presence.

Unless otherwise defined, all terms (including technical terms and scientific terms) used herein have the same meaning as those with ordinary knowledge or commonly understood in the technical field to which this invention belongs. It should be understood that, terms (such as those defined in commonly used dictionaries) should be interpreted to have meanings consistent with their meanings in the relevant technical background, and should not be interpreted in an idealized or overly formal sense, unless expressly so defined herein.

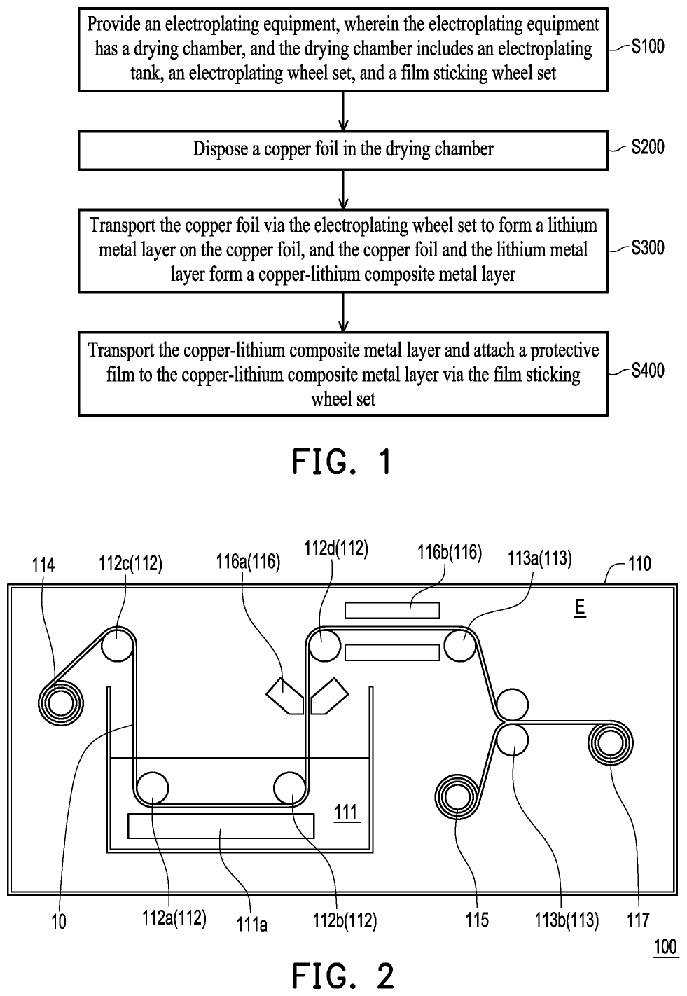

FIG. 1 is a flowchart of a manufacturing method of a lithium battery negative electrode of an embodiment of the invention. The manufacturing method of the lithium battery negative electrode of the invention may include at least the following steps. Please refer to FIG. 1. First, an electroplating equipment is provided, wherein the electroplating equipment has a drying chamber, and the drying chamber includes an electroplating tank, an electroplating wheel set, and a film sticking wheel set (step S100).

Next, a copper foil is disposed in the drying chamber (step S200). The electroplating wheel set transports the copper foil to form a lithium metal layer on the copper foil, and the copper foil and the lithium metal layer form a copper-lithium composite metal layer (step S300). Next, the film sticking wheel set transports the copper-lithium composite metal layer and attaches a protective film to the copper-lithium composite metal layer (step S400). Accordingly, the lithium battery negative electrode of the invention is manufactured in the drying chamber, and via the electroplating wheel set in the drying chamber, lithium metal may be continuously deposited on the copper foil in the electroplating tank to form the copper-lithium composite metal layer. And via the film sticking wheel set in the drying chamber, the protective film may be continuously attached to the copper-lithium composite metal layer pulled out from the electroplating tank. In this way, the low-reactivity copper foil and protective film may effectively reduce the probability of lithium metal being oxidized, so the composite negative electrode structure produced thereby may effectively improve the performance of lithium batteries and facilitate mass production.

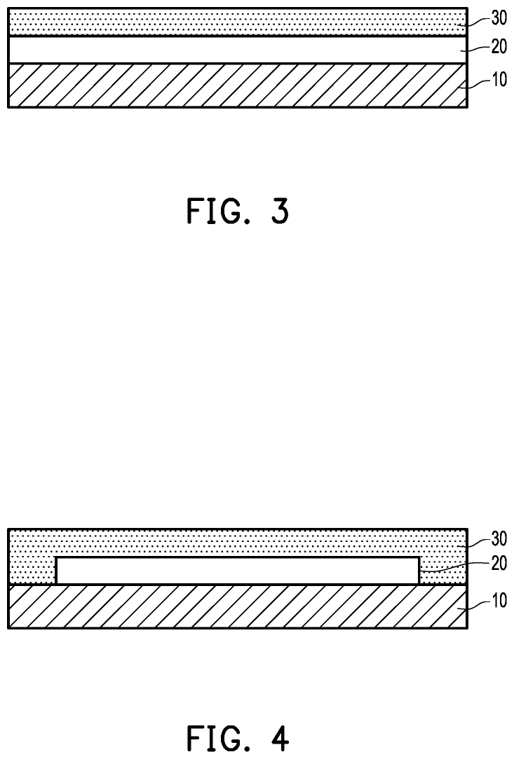

FIG. 2 is a schematic diagram of an electroplating equipment of an embodiment of the invention. FIG. 3 is a schematic cross-sectional diagram of a lithium battery negative electrode of an embodiment of the invention. FIG. 4 is a schematic cross-sectional diagram of a lithium battery negative electrode of another embodiment of the invention.

In an embodiment, the manufacturing method of the lithium battery negative electrode may be manufactured by an electroplating equipment 100 of FIG. 2, but the invention is not limited thereto. Without departing from the spirit and scope of the invention, the electroplating equipment may have other suitable devices and configurations not described herein.

Please refer to FIG. 2 to FIG. 4, the electroplating equipment 100 has a drying chamber 110, and the drying chamber 110 includes an electroplating tank 111, an electroplating wheel set 112, and a film sticking wheel set 113. In an embodiment, the dew point temperature of the drying chamber is, for example, less than −40° C., and an environment E of the drying chamber 110 is formed by an inert gas to reduce the probability of lithium metal reacting with water or oxygen, etc. in the environment during the electroplating process, thus further improving the production quality of the lithium battery negative electrode, but the invention is not limited thereto. Here, the inert gas is, for example, nitrogen, argon, or other suitable inert gases and combinations thereof.

More specifically, the electroplating tank 111 includes a first electrode 111a, and the electroplating wheel set 112 includes a first guide wheel 112a and a second guide wheel 112b disposed in the electroplating tank 111 and a first conductive wheel 112c and a second conductive wheel 112d disposed outside the electroplating tank 111, wherein the invention does not limit the specific forms of the first guide wheel 112a, the second guide wheel 112b, the first conductive wheel 112c, and the second conductive wheel 112d, as long as the first guide wheel 112a and the second guide wheel 112b may be configured so that the copper foil 10 in the electroplating tank 111 is parallel to the first electrode 111a, and the first conductive wheel 112c and the second conductive wheel 112d may be used as second electrodes (the counter electrodes of the first electrode 111a), which all belong to the scope of the invention, wherein the material of the first guide wheel 112a and the second guide wheel 112b may be any suitable material that does not react with the electroplating solution, the material of the first electrode 111a includes lithium metal, stainless steel, or the like, and the material of the first conductive wheel 112c and the second conductive wheel 112d includes titanium, stainless steel.

In the present embodiment, the drying chamber 110 further includes a copper foil supply device 114 connected to the electroplating wheel set 112, wherein the copper foil 10 is, for example, a copper foil roll, and the copper foil device 114 may be in the form of a roller to continuously send the copper foil roll to the electroplating wheel set 112 for the electroplating process. Moreover, as shown in FIG. 2, for example, the copper foil 10 first passes through the first conductive wheel 112c, and then is pulled into the electroplating tank 111 by the first guide wheel 112a and the second guide wheel 112b. And the direction of the copper foil 10 is adjusted by the first guide wheel 112a and the second guide wheel 112b, so that the copper foil 10 is parallel to the first electrode 111a (FIG. 2 schematically shows that the copper foil 10 is parallel in the horizontal direction. However, in an embodiment not shown, the copper foil 10 may also be parallel in the vertical direction). The copper foil 10 undergoes the electroplating process to deposit lithium metal (the lithium metal layer 20 in FIG. 3 and FIG. 4) on the copper foil 10 to form a copper-lithium composite metal layer, and then leaves the electroplating tank 111 and is pulled to the second conductive wheel 112d. Here, the thickness of the copper foil 10 may be between 6 microns and 35 microns, and the deposition thickness of the lithium metal may be between 0.5 microns and 20 microns, but the invention is not limited thereto.

It should be noted that, the electroplating solution in the electroplating tank 111 includes a lithium salt and an organic solvent, and the lithium salt includes lithium hexafluorophosphate, lithium hexafluoroborate, lithium bis(trifluoromethylsulfonate)amide, or a combination thereof, the organic solvent includes ethylene carbonate, propylene carbonate, dimethyl carbonate, ethylene glycol dimethyl ether, dimethyl ether, or a combination thereof, and the specific details of the electroplating process may be understood by those having ordinary skill in the art, and are not repeated here.

Moreover, the film sticking wheel set 113 includes a third guide wheel 113a connected to the second conductive wheel 112d and a pressing and laminating wheel 113b connected to the third guide wheel 113a, and the drying chamber 110 further includes a protective film device 115 connected to the film sticking wheel set 113, wherein the protective film (the protective film 30 in FIG. 3 and FIG. 4) is, for example, a polyimide (PI) film, a polyester (PET) film, or a water and gas barrier film, and the protective film device 115 may be in the form of a roller to continuously send the above roll to the pressing and laminating wheel 113b for the film sticking process. Here, the protective film (the protective film 30 in FIG. 3 and FIG. 4) may have any suitable thickness, which is not limited by the invention.

In an embodiment, the water and gas barrier film is, for example, an aluminum composite film roll (aluminum composite film) as a non-stretch polypropylene film (CPP film) evaporated aluminum, or a CPP film attached to an aluminum foil (for example, the thickness is between 6 microns and 35 microns), so that with the water and oxygen barrier properties of aluminum, lithium metal may be more effectively protected and may be stably prevented from oxidizing with water or air in the environment. However, the invention is not limited thereto, and other water and gas barrier films may also be used, such as a water and gas barrier film with the trade name Mitsui Chemicals TAKELAC™ WPB-341. Here, the water and gas barrier film preferably has a water vapor transmission rate of 0.5 g/m²/day and an oxygen transmission rate of 0.5 cc/m²/day or less.

In an embodiment, as shown in FIG. 3, the lithium metal layer 20 may completely cover the surface of the copper foil 10, so the subsequent protective film 30 covering the lithium metal layer 20 does not need to be directly in contact with the copper foil 10. However, the invention is not limited thereto. In another embodiment, as shown in FIG. 4, the lithium metal layer 20 may partially cover the surface of the copper foil 10 and expose a portion of the surface of the copper foil 10. Therefore, the protective film 30 subsequently covered on the lithium metal layer 20 may be directly in contact with the lithium metal layer 20 and the copper foil 10. That is, the protective film 30 at least completely covers the surface of the lithium metal layer 20, and optionally covers the surface of the copper foil 10.

In some embodiments, the drying chamber 110 further includes a drying device 116, and the drying device 116 is configured to remove the organic solvent on the copper-lithium composite metal layer, wherein the drying device 116 includes an air knife, a roller, an infrared (IR) heater, or a combination thereof. For example, as shown in FIG. 2, the drying device 116 includes a first drying device 116a and a second drying device 116b, the first drying device 116a may be disposed between the second conductive wheel 112b and the second conductive wheel 112d, and the second drying device may be disposed between the second conductive wheel 112d and the third conductive wheel 113a, wherein the drying device 116 may be simultaneously disposed at two sides of the copper-lithium composite metal layer to simultaneously dry the organic solvent at two sides, but the invention is not limited thereto.

In an embodiment, the drying chamber 110 further includes a winding device 117 connected to the film sticking wheel set 113 to wind and shape the composite negative electrode structure including the copper foil 10, the lithium metal layer 20, and the protective film 30. In this way, the process speed of the subsequent lithium battery may be increased to meet the needs of mass production.

The following example is given to illustrate the effects of the invention, but the patent scope of the invention is not limited to the scope of the example.

### Example

First, 6 μm to 8 μm of copper foil and a protective film (water and gas barrier film of TAKELAC™ WPB-341), electroplating solution: solvent: ethylene glycol dimethyl ether (DOL): dimethyl ether (DME)=1:1, 1% to 5% of 1M lithium salt (LiTFSI) and lithium nitrate LiNO₃ for the negative electrode were prepared, and a pulling lead was mounted on the electroplating equipment (100), wherein the drying chamber always maintained the water vapor dew point below −40° C.

Step 2: the flow rate of nitrogen gas into the electroplating tank (111) was 50 cc/min.

Step 3: the electroplating production line was operated via the manufacturing method of the lithium battery negative electrode at a production rate of 0.1 M/min to 30

M/min until the length of each roll was about 3000 meters to 10000 meters (m), that is, production is stopped.

Step 4: the materials were collected and the finished product was taken out, and step 1 was repeated to continue production to achieve mass production.

Based on the above, the lithium battery negative electrode of the invention is manufactured in the drying chamber, and via the electroplating wheel set in the drying room, lithium metal may be continuously deposited on the copper foil in the electroplating tank to form the copper-lithium composite metal layer. And via the film sticking wheel set in the drying chamber, the protective film may be continuously attached to the copper-lithium composite metal layer pulled out from the electroplating tank. In this way, the low-reactivity copper foil and protective film may effectively reduce the probability of lithium metal being oxidized, so the composite negative electrode structure produced thereby may effectively improve the performance of lithium batteries and facilitate mass production.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A manufacturing method of a lithium battery negative electrode, comprising:
providing an electroplating equipment, wherein the electroplating equipment has a drying chamber, and the drying chamber comprises an electroplating tank, an electroplating wheel set, and a film sticking wheel set;
disposing a copper foil in the drying chamber;
transporting the copper foil via the electroplating wheel set to form a lithium metal layer on the copper foil, and the copper foil and the lithium metal layer form a copper-lithium composite metal layer; and
transporting the copper-lithium composite metal layer and attaching a protective film to the copper-lithium composite metal layer via the film sticking wheel set.

2. The manufacturing method of the lithium battery negative electrode of claim 1, wherein the electroplating tank comprises a first electrode, and the electroplating wheel set comprises:
a first guide wheel and a second guide wheel disposed in the electroplating tank, wherein the first guide wheel and the second guide wheel are configured so that the copper foil in the electroplating tank is parallel to the first electrode; and
a first conductive wheel and a second conductive wheel disposed outside the electroplating tank, wherein the first conductive wheel and the second conductive wheel are used as second electrodes.

3. The manufacturing method of the lithium battery negative electrode of claim 1, wherein the drying chamber further comprises a copper foil supply device and a protective film supply device, the copper foil supply device is connected to the electroplating wheel set, and the protective film supply device is connected to the film sticking wheel set.

4. The manufacturing method of the lithium battery negative electrode of claim 1, wherein a material of the protective film comprises a polyimide film, a polyester film, or a water and gas barrier film.

5. The manufacturing method of the lithium battery negative electrode of claim 1, wherein the drying chamber further comprises a drying device, and the drying device is configured to remove an organic solvent on the copper-lithium composite metal layer.

6. The manufacturing method of the lithium battery negative electrode of claim 5, wherein the drying device comprises an air knife, a roller, an infrared heater, or a combination thereof.

7. The manufacturing method of the lithium battery negative electrode of claim 1, wherein an environment of the drying chamber is formed by an inert gas.

8. The manufacturing method of the lithium battery negative electrode of claim 1, wherein the protective film at least completely covers a surface of the lithium metal layer.

9. The manufacturing method of the lithium battery negative electrode of claim 1, wherein the protective film is directly in contact with the lithium metal layer and the copper foil.

10. The manufacturing method of the lithium battery negative electrode of claim 1, wherein an electroplating solution in the electroplating tank comprises a lithium salt and an organic solvent, and the lithium salt comprises lithium hexafluorophosphate, lithium hexafluoroborate, lithium bis(trifluoromethylsulfonate)amide, or a combination thereof, and the organic solvent comprises ethylene carbonate, propylene carbonate, dimethyl carbonate, glycol dimethyl ether, dimethyl ether, or a combination thereof.
